(19) United States
(12) Patent Application Publication
(10) Pub. No.: US 2023/0114877 A1
(43) Pub. Date: Apr. 13, 2023

(54) Unsupervised Latent Low-Rank Projection Learning Method for Feature Extraction of Hyperspectral Images

(71) Applicant: SOUTHWEST ELECTRONICS TECHNOLOGY RESEARCH INSTITUTE ( CHINA ELECTRONICS TECHNOLOGY GROUP CORPORATION, Chengdu, Sichuan (CN)

(72) Inventors: Lei PAN, Chengdu, Sichuan (CN); Ying CUI, Chengdu, Sichuan (CN); Xifeng HUANG, Chengdu, Sichuan (CN); Kan WANG, Chengdu, Sichuan (CN); Hongzhou LIAO, Chengdu, Sichuan (CN); Chunbao LI, Chengdu, Sichuan (CN); Weiqing CHEN, Chengdu, Sichuan (CN)

(21) Appl. No.: 17/913,854

(22) PCT Filed: Mar. 8, 2021
(86) PCT No.: PCT/CN2021/079597

§ 371 Date: Sep. 23, 2022

(30) Foreign Application Priority Data
Jun. 29, 2020 (CN) 202010609017.2

(51) Int. Cl. G06V 10/77; G06V 10/764; G06V 10/776

(52) U.S. Cl. CPC G06V 10/7715; G06V 10/764; G06V 10/776

(57) ABSTRACT

Provided is a method for feature extraction of a hyperspectral images based on unsupervised latent low-rank projection learning, including: dividing hyperspectral images data into a training set and a test set in proportion; configuring a robust weight function, constructing a spectral constraint matrix according to the training set, and constructing a graph regularization constraint according to a locality preserving projection rule; approximately decompose row representation coefficients of a latent low-rank representation model, constructing a latent low-rank projection learning model in combination with the spectral constraint matrix and the graph regularization constraint; optimizing and solving the latent low-rank projection learning model; and outputting classes of all samples in the test set, and taking low-dimensional features of the training set as training samples of a support vector machine, to classify low-dimensional features of the test set, and evaluating, by the quality of classification results, performance of feature extraction.

### TECHNICAL FIELD

The present disclosure relates to a remote sensing image processing technology in multiple fields of aviation, spaceflight, agricultural management, disaster forecasting, environment monitoring, resource exploration, land planning and utilization, disaster dynamic monitoring, crop yield estimation, meteorological forecasting, etc., and in particular to a method for feature extraction of a hyperspectral images based on unsupervised latent low-rank projection learning.

### BACKGROUND

The hyperspectral images features image-spectral integration, and is a state-of-the-art remote sensing technology developed recently at home and abroad. Compared with the multi-spectral image, the hyperspectral images has multiple spectral bands, high spectral resolution and a narrow band width, and can distinguish and recognize physical objects with high reliability. However, these advantages of the hyperspectral images are achieved at the expense of high data dimensions and large amount of data, and correlation between bands of the hyperspectral images is high, resulting in redundancy of information. Not all bands are required for image processing such as target recognition and classification, and accordingly, it is necessary to reduce the dimension of data of the hyperspectral images. Feature extraction of the remote sensing image is the key technology to automatically recognize the remote sensing image. Remote sensing is a comprehensive technology that obtains feature information of a target object by means of a sensor loaded on a certain platform without direct contact with the target object, and then extracts, determines, processes and analyzes the obtained information, and is the only current means to provide dynamic observation data on a global scale. The hyperspectral images is obtained through an imaging spectrometer. Hyperspectral remote sensing is a three-dimensional remote sensing technology formed by adding one-dimensional spectral remote sensing on the basis of traditional two-dimensional space remote sensing. Hyperspectral images data represents the form of three-dimensional cubes, and cube data well fuses space information and spectral information of a physical object. The hyperspectral images data has the space characteristic describing space features of the corresponding physical object, and the spectral characteristic describing spectral information of each pixel of the corresponding physical object. The hyperspectral images will be inevitably polluted by various noises, such as Gaussian noise, impulse noise and fringe in the process of acquisition and transmission, seriously restricting further application of the hyperspectral images. Moreover, the dimension of the hyperspectral images is increased dramatically, resulting in “dimension disaster”. The hyperspectral remote sensing technology refers to a technology that utilizes an airborne or spaceborne hyperspectral imaging spectrometer to obtain the hyperspectral images formed by stacking dozens or hundreds of continuous spectral bands including feature information of physical objects, and analyzes and processes the obtained hyperspectral images to cognize the physical objects in detail. The hyperspectral images is composed of one spectral dimension and two spatial dimensions. Each of pixels in the image represents an object in a certain region on the ground. Different space resolutions represent different regions. Each of the pixels corresponds to a continuous spectral curve. In response to the hyperspectral images being processed unduly, its rich information is likely to become a disadvantage, instead of an advantage. The super-large amount of data having dozens or hundreds of spectral bands will bring inconvenience to later processing in multiple ways, especially in computation and storage in the process of data processing. In terms of current hardware conditions, directly processing such a large amount of data is difficult but possible, with much higher cost. Moreover, due to spectral similarity, multiple hundreds of continuous narrow spectral bands are similar, such that there is data redundancy to a certain extent. Redundant data contributes little to data processing, but occupies a limited storage space and reduces efficiency of data processing. The collected large amount of detailed data will include noise without exception, which will pollute original pure data and have a negative impact on precision of classification and recognition of the physical objects. In response to the disadvantage of the hyperspectral data cannot be well overcome, the hyperspectral data will become “informative and knowledge-poor”.

Apart from rich spectral information, the hyperspectral images has excellent space structure features. That is to say, the hyperspectral images has so-called characteristic of “image-spectral integration”. Therefore, the hyperspectral images has been used in a wide range of fields of agricultural management, environment monitoring, military reconnaissance, etc. However, the hyperspectral images has the problems of a high spectral dimension, large information redundancy, few labeled training samples, etc., which seriously restrict further promotion of the hyperspectral images processing technology. The research shows that the feature extraction technology is an effective means to solve the problems of the high data dimension and large information redundancy and is also a research hot spot in the hyperspectral images processing technology. Various feature extraction technologies of the image have a vital effect in the process of classification and recognition of remote sensing images. Feature extraction of the remote sensing image mainly includes three parts: spectral feature extraction, texture feature extraction and shape feature extraction. Spectral information reflects the magnitude of electromagnetic wave energy reflected by physical objects and is the basic basis for visual image interpretation. In current research of remote sensing image processing, spectral features are utilized in most cases.

The feature extraction technology transforms high-dimensional data into low-dimensional features by means of mapping or transformation, and retains valuable information in the data while reducing the dimension of the data, thereby facilitating subsequent classification or other processing. So far, research scholars have provided a large number of methods for feature extraction, and constantly combined new theories and technologies to expand the scope of the methods for feature extraction. Generally, the methods for feature extraction can be divided into an unsupervised algorithm, a semi-supervised algorithm and a supervised algorithm according to the presence or absence of the labeled training samples. Principal component analysis (PCA) is the most classical unsupervised method for feature extraction, which finds a linear projection matrix by maximizing a variance and retains the most important feature information in the data. Later, research scholars have put forward minimum noise separation transform, independent principal component analysis and other methods. As a classical unsupervised feature extraction algorithm, latent low-rank representation (LatLRR) has been used in the field of pattern recognition. However, the feature dimension obtained by the algorithm cannot be reduced, and since the algorithm learns two low-rank matrices separately, the algorithm cannot ensure overall optimization. In addition, the algorithm ignores residuals in the learning process of samples. The unsupervised discriminant projection (UDP) criterion function can be described by maximizing the ratio of non-local divergence to local divergence. After the UDP algorithm is used for projection, although samples adjacent to each other are concentrated and samples away from each other are separated to the greatest extent, really effective discrimination information obtained is so limited due to high redundancy of information between feature components. It is impossible to eliminate correlation between the feature components of pattern samples, such that the error rate converges very slowly with increase in the number of discrimination vectors at some time. However, in response to that these unsupervised methods do not use sample label information, performance of feature extraction cannot satisfy actual demands. Therefore, some scholars provided a linear discriminant analysis method. Starting from the mean and variance of data, the scholars configured an intra-class divergence matrix and an inter-class divergence matrix, to enhance aggregation of the same class of data and separability of different classes of data with minimum intra-class divergence and maximum inter-class divergence. However, based on the statistical theory, the above methods for feature extraction all have the advantages of a simple model, easy understanding and easy solution, and the disadvantage of ignoring the spatial structure of the data, and lack a strong representation of the data. Such methods belong to the category of traditional methods for feature extraction.

With successful application of sparse representation in face recognition, sparse representation based methods for feature extraction are emerging constantly. For example, the sparse graph embedding model constructed in an unsupervised manner defines adjacent pixels of a pixel by means of the sparse reconstruction coefficient of the pixel, to further obtain a sparse graph. Then, the locality preserving projection technology is utilized to obtain a low-dimensional projection matrix. Based on sparse graph embedding as well as the sample label information, some scholars provided a sparse graph discriminant analysis model, which was expanded into a block sparse graph discriminant analysis model in a manner of intra-class composition. Subsequently, weighted sparse graph discriminant analysis, Laplace regularized collaboration diagram, sparse graph learning and other methods were derived. However, the sparse graph can only capture local structure information of hyperspectral data. Some scholars deemed that global structure information is more important, and therefore provided a low-rank graph embedding model on the basis of low-rank representation. The algorithm can keep overall geometry of original data in each space to the greatest extent, and can effectively restore a damaged face image. However, existing low-rank representation algorithms have poor stability in denoising and restoring noisy images in training samples, resulting in a low recognition rate. The low-rank representation model is an unconstrained algorithm having certain limitations, has special requirements for the sparsity of the sparse matrix, and has an unstable denoising effect. In response to that certain conditions are satisfied, a characteristic of the low-rank algorithm is that the relation between data from the same sub-space can be accurately revealed by means of the low-rank representation coefficient, and the data sub-space can be segmented according to the characteristic. However, the algorithm cannot keep local geometry of data while keeping the overall geometry of original data, is sensitive to local noise and thus has a poor effect of denoising and restoration. Subsequently, in combination with sparse and low-rank graphs, scholars provided a sparse low-rank graph discriminant analysis model, and moreover, captured local structures and global structures of hyperspectral data, such that the performance of feature extraction is significantly improved.

At present, the LatLRR is mainly used in sub-space segmentation, i.e., a group of given data. The group of data is sourced from certain sub-spaces. By means of low-rank representation, the data from these sub-spaces can be clustered and specific sub-spaces from which the data is sourced can be found. Firstly, there are various methods for sub-space segmentation, such as probability model based methods. In consideration of strong correlation between adjacent hyperspectral bands, Kumar et al. provided to reduce the feature dimension of the hyperspectral images by means of a method for fusing adjacent hyperspectral bands. The method firstly segments the hyperspectral images into multiple band sub-sets according to specific criteria, and finally computes fused bands of each band sub-set by means of weighted summation, to obtain the dimension-reduced hyperspectral data. The method can effectively retain physical characteristics of the hyperspectral data while reducing the dimension of the hyperspectral data. However, band segmentation usually involves complex clustering and optimization processes, which increases computation complexity of dimension reduction methods. The hyperspectral data is inevitably affected by illumination conditions, atmospheric conditions, sensor accuracy and other factors in the imaging process, and accordingly, there are different degrees of noises in the data. These noises seriously affect performance of feature extraction. From another point of view, with ongoing development of high-resolution projects in China, multiple valuable hyperspectral remote sensing data have been obtained. However, scarce labeled data has become the new problem, and data has to be marked with enormous manpower and material resources. In this case, unsupervised methods for feature extraction have broader application prospects.

### SUMMARY

At least some embodiments of the present disclosure provide an unsupervised method for extracting hyperspectral features, with high efficiency and high robust, so as to at least partially solve the problems of high spectral dimension, large information redundancy, few labeled samples, etc. of hyperspectral data in the related art.

In an embodiment of the present disclosure, a method for feature extraction of hyperspectral images based on unsupervised latent low-rank projection learning is provided. The method includes:

dividing input hyperspectral data without sample label information into a training set and a test set in proportion; configuring a robust weight function, to compute a spectral similarity between each two samples in the training set, constructing a spectral constraint matrix according to the training set, and constructing a graph regularization constraint according to a locality preserving projection rule; approximately decompose row representation coefficients of a latent low-rank representation model into a product of two matrices of the same scale, and constructing a latent low-rank projection learning model with one of the matrices as a projection matrix in combination with the spectral constraint matrix and the graph regularization constraint; using an alternating direction method of multipliers to optimize and solve the latent low-rank projection learning model, to obtain a low-dimensional projection matrix, and extracting low-dimensional representation features of the test set; and using a support vector machine classifier to output classes of all samples in the test set by taking the low-dimensional features of the training set as training samples of the support vector machine, to classify the low-dimensional features of the test set to obtain a classification result, and evaluating the performance of feature extraction by the quality of classification results.

Compared with the related art, the embodiment of the present disclosure has the technical effects:

(1) The embodiment of the present disclosure constructs the spectral constraint matrix according to the training set, and constructs the graph regularization constraint according to the locality preserving projection rule; introduces the latent low-rank representation model, and effectively overcomes adverse effects of interference factors of noise, etc. by means of representation learning of a row space and a column space; and moreover, decomposes the row representation coefficients in the model into the product of two matrices of the same scale, and uses one of the matrices as the projection matrix, and the new model may extract low-dimensional features of any dimension compared with the original latent low-rank representation model.

(2) The embodiment of the present disclosure configures the robust weight function, the spectral constraint and the graph regularization constraint in order to make up for the defect that latent low-rank representation may capture the global structure of data, the spectral constraint preserves the local structure of data from the original data space, and the graph regularization constraint captures the local structure of the data from the low-dimensional feature space; and combination of the spectral constraint and the graph regularization constraint with the latent low-rank representation model may better preserve intrinsic structures of hyperspectral data and improve separability of the low-dimensional features.

(3) The embodiment of the present disclosure approximatively decomposes the row representation coefficients of the latent low-rank representation model into the product of the two matrices of the same scale, constructs the latent low-rank projection learning model with one of the matrices as the projection matrix in combination with the spectral constraint matrix and the graph regularization constraint, configures an integrated model by combing the representation learning and projection learning, and may obtain a low-dimensional projection by means of optimization solution of the model, thereby effectively avoiding a complex process of a graph embedding model; and representation learning interacts with projection learning, such that discrimination of the low-dimensional projection may be obviously improved.

The embodiment of the present disclosure uses the alternating direction method of multipliers to optimize and solve the latent low-rank projection learning model, obtains the low-dimensional projection matrix, extracts the low-dimensional representation features of the test set, uses the support vector machine classifier to output classes of all the test set samples, uses the low-dimensional features of the training set as the training samples of the support vector machine, to classify the low-dimensional features of the test set to obtain a classification result, and evaluates the performance of feature extraction by the quality of the classification result. Experiments on provided real hyperspectral data sets show that the provided method has the performance of feature extraction obviously superior to that of other unsupervised methods for feature extraction, and the extracted low-dimensional features may obtain higher classification precision of the hyperspectral images.

The embodiment of the present disclosure is suitable for feature extraction of the hyperspectral images. The core of the embodiment of the present disclosure is the construction of the creative model by integrating latent low-rank representation learning and projection learning, simultaneously combining with the spectral constraint and the graph regularization constraint, which can accurately capture intrinsic structures of the data, thereby further improving discrimination of the low-dimensional features. The embodiment of the present disclosure is effective as long as feature extraction or dimensionality reduction of the image is involved.

### BRIEF DESCRIPTION OF THE DRAWINGS

FIG. 1 is a flow chart of an unsupervised latent low-rank projection learning based feature extraction method for hyperspectral images according to an embodiment of the present disclosure.

FIG. 2 is a flow chart of the solution method for the latent low-rank projection learning model in FIG. 1 according to an embodiment of the present disclosure.

In order to make the objectives, technical solutions and advantages of the present disclosure clearer, the present disclosure will be further described in detail below in combination with the accompanying drawings and specific implementations, but the scope of application of the present disclosure is not limited there to: the present disclosure will be further described in detail below in combination with particular embodiments with reference to the accompanying drawings.

### DETAILED DESCRIPTION

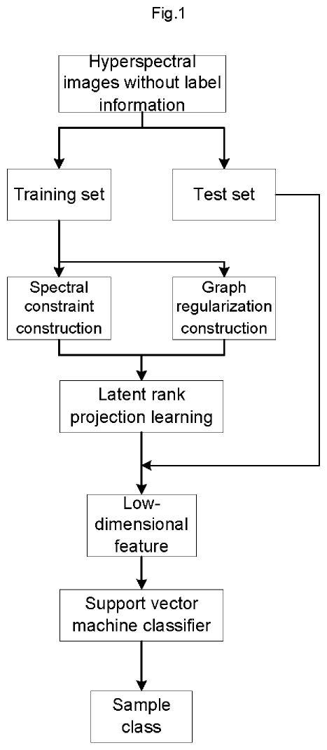

With reference to FIG. 1, an embodiment of the present disclosure includes: divide input hyper-spectral image data without sample label information into a training set and a test set in proportion; configure a robust weight function, to compute a spectral similarity between each two samples in the training set, construct a spectral constraint matrix according to the training set, and construct a graph regularization constraint according to a locality preserving projection rule; approximately decompose row representation coefficients of a latent low-rank representation model into a product of two matrices of the same scale, and construct a latent low-rank projection learning model with one of the matrices as a projection matrix in combination with the spectral constraint matrix and the graph regularization constraint; and use an alternating iterative method of multipliers to optimize and solve the latent low-rank projection learning model, to obtain a low-dimensional projection matrix, extract low-dimensional representation features of the test set, use a support vector machine classifier to output classes of all samples in the test set, and take the low-dimensional features of the training set as training samples of the support vector machine, to classify the low-dimensional features of the test set to obtain a classification result, and evaluating the performance of feature extraction by the quality of classification results. The embodiment of the present disclosure specifically includes:

At step 1, in an optional embodiment, divide input hyperspectral data into a training set and a test set. The step includes: divide the hyperspectral data with (N+M) samples into a training set X=[x₁,x₂, . . . ,x_{N}]∈R^{d×N} including N samples, and a test set Y=[y₁,y₂, . . . ,y_{M}]∈R^{d×M} including M samples in a set proportion, ∈ representing belong to, wherein R represents a real number space, and d represents a spectral dimension of each sample, and the total number of the samples of the input hyperspectral data being (N+M).

At step 2, construct a spectral constraint matrix. The step includes: construct the spectral constraint matrix C according to the training set and configure a robust weight function to represent an ij-th element Cᵢⱼ in the spectral constraint matrix C as:

$${C}_{ij} = 1 - {( 1 - {( \frac{dist ( {x}_{i} , {x}_{j} )}{{max}_{∀ t} ( dist ( {x}_{i} , {x}_{j} ) )} )}^{2} )}^{2} ,$$

wherein xᵢ represents an i-th training sample, xⱼ represents a j-th training sample, dist(xᵢ,xⱼ) represents a Euclidean distance between the training sample xᵢ and the training sample xⱼ, ∀ represents any element, and max_{∀i}(dist(xᵢ,xⱼ)) represents a maximum value of a distance between any sample xᵢ with a mark number i and the sample xⱼ.

At step 3, construct a graph regularization constraint. The step includes: according to a locality preserving projection rule, the graph regularization constraint is as following formula:

$${min}_{{P}^{T} {XDX}^{T} P} {\sum }_{i , j = 1}^{N} {‖ {P}^{T} {x}_{i} - {P}^{T} {x}_{j} ‖}_{2}^{2} {W}_{ij} = {min}_{Tr ( {P}^{T} X D {X}^{T} P = 1 )} Tr ( {P}^{T} X L {X}^{T} P ) ,$$

wherein min represents a minimum value of the function, P represents a projection matrix, i and j represents element mark numbers, Σ represents the sum of elements, ∥⋅∥₂² represents a square of a 2-norm, xᵢ represents an i-th training sample, xⱼ represents a j-th training sample, T represents a transpose of a matrix, Wᵢⱼ represents an ij-th element of the graph weight matrix W, D is a diagonal matrix, a diagonal element of the diagonal matrix is the sum of each row or each column of the graph weight matrix, L represents the Laplacian matrix, and Tr(⋅)represents a trace of the matrix.

The graph weight matrix W is computed by the following equation:

$${W}_{ij} = \{ \begin{matrix}1 , & {x}_{i} ∈ {N}_{k} ( {x}_{j} ) or {x}_{j} ∈ {N}_{k} ( {x}_{i} ) \\ 0 , & or else\end{matrix} ,$$

xᵢ represents an i-th training sample, xⱼ represents a j-th training sample, ∈ represents belong to, and Nₖ(xⱼ) represents K nearest neighbor samples of the j-th training sample xⱼ.

At Step 4, it further includes:

the latent low-rank representation model can be represented as:

$${min}_{Z , L , E} {‖ Z ‖}_{*} + {‖ L ‖}_{*} + λ {‖ E ‖}_{2 , 1} ,$$

$$s . t . X = XZ + LX + E ,$$

wherein min represents a minimum value of the function, X represents a training sample set, Z represents a column space representation coefficient, L represents a row space representation coefficient, E represents noise, ∥⋅∥, represents a nuclear norm of a matrix, ∥⋅∥_{2,i} represents a 21-norm of the matrix, λ represents a regularization parameter, and s.t. represents a constraint.

In the embodiment, the row space representation coefficients are decomposed, which can be represented by the product of two matrices with the same dimension, and are correspondingly transformed to obtain

$${min}_{Z , P , Q , E} {‖ Z ‖}_{*} + \frac{β}{2} {‖ P ‖}_{F}^{2} + λ {‖ E ‖}_{1} ,$$

$$s . t . X = XZ + {QP}^{T} X + E , {Q}^{T} Q = I ,$$

P and Q represents the decomposition matrices, β represents a regularization parameter, ∥⋅∥_{F}² represents a square of the F-norm of the matrix, F is a flag of an F-norm, ∥⋅∥₁ represents a 1-norm of the matrix, T represents a transpose of the matrix, and I represents a unit matrix. Further, in combination with the spectral constraint matrix in step 2 and the graph regularization constraint in step 3, a latent low-rank projection learning model is constructed, which has an expression is as following formula:

$${min}_{Z , P , Q , E} {‖ C ⊙ Z ‖}_{*} + \frac{β}{2} {‖ P ‖}_{F}^{2} + λ {‖ E ‖}_{1} + γ Tr ( {P}^{T} {XLX}^{T} P ) , . s . t . X = XZ + {QP}^{T} X + E , {Q}^{T} Q = I$$

⊙ represents a dot product of matrix elements, and γ represents a regularization parameter.

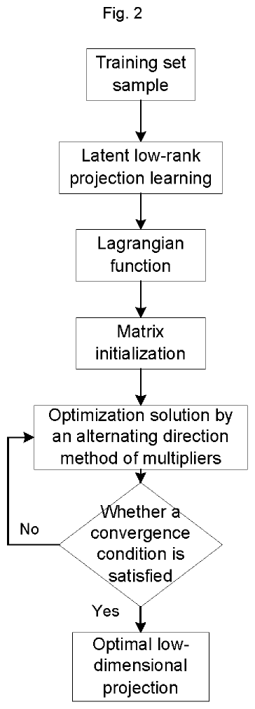

As shown in FIG. 2, solve the latent low-rank projection learning model, which includes:

use an alternating direction method of multipliers to solve the latent low-rank projection learning model, and introduce an auxiliary variable A and a variable B by means of an alternating direction method of multipliers, to obtain an optimization model as following formulas:

$${min}_{Z , P , Q , A , B , E} {‖ C ⊙ A ‖}_{*} + \frac{β}{2} {‖ P ‖}_{F}^{2} + λ {‖ E ‖}_{1} + γ Tr ( {B}^{T} {XLX}^{T} B ) ,$$

$$s . t . X = XZ + {QP}^{T} X + E , Z = A , P = B , {Q}^{T} Q = I$$

a Lagrangian function of the above optimization model as following formulas:

$$ℓ ( Z , A , P , B , Q , E )$$

$$= {‖ C ⊙ A ‖}_{*} + \frac{β}{2} {‖ P ‖}_{F}^{2} + λ {‖ E ‖}_{1} + γ Tr ( {B}^{T} {XLX}^{T} B )$$

$$+ 〈 {Y}_{1} , X - XZ - {QP}^{T} X - E 〉 + 〈 {Y}_{2} , Z - A 〉 + 〈 {Y}_{3} , P - B 〉$$

$$+ \frac{μ}{2} ( {‖ X - XZ - {QP}^{T} X - E ‖}_{F}^{2} + {‖ Z - A ‖}_{F}^{2} + {‖ P - B ‖}_{F}^{2} )$$

wherein [symbol] (⋅) represents the Lagrangian function, [symbol] ⋅ [symbol] represents a matrix inner product, Y₁, Y₂ and Y₃ represents Lagrangian multipliers, and μ represents a penalty factor.

Matrices in the Lagrangian function are initialized: Z=A=0, P=B=0, E=0, Y₁=0, Y₂=0 and Y₃=0. A rule of the alternating direction method of multipliers is to update only one variable each time and keep other variables unchanged, and variable values of a (t+1)-th iteration are

$${A}_{t + 1} = {min}_{A} {‖ C ⊙ A ‖}_{*} + \frac{{μ}_{t}}{2} {‖ {Z}_{t} - A + \frac{{Y}_{2 , t}}{{μ}_{t}} ‖}_{F}^{2} = ( {μ}_{t} {Z}_{t} + {Y}_{2 , t} ) / ( 2 ( C ⊙ C ) + {μ}_{t} 1 ) ,$$

$${Z}_{t + 1} = \frac{{μ}_{t}}{2} ( {‖ X - XZ - {Q}_{t} {P}_{t}^{T} X - {E}_{t} + \frac{{Y}_{1 , t}}{{μ}_{t}} ‖}_{F}^{2} + {‖ Z - {A}_{t + 1} + \frac{{Y}_{2 , t}}{{μ}_{t}} ‖}_{F}^{2} )$$

$$= {( {X}^{T} X + I )}^{- 1} ( {X}^{T} {S}_{1} + {A}_{t + 1} - \frac{{Y}_{2 , t}}{{μ}_{t}} )$$

$${B}_{t + 1} = γ Tr ( {B}^{T} {XLX}^{T} B ) + \frac{{μ}_{t}}{2} ( {‖ P - {B}_{t + 1} + \frac{{Y}_{3 , t}}{{μ}_{t}} ‖}_{F}^{2} + {‖ X - XZ - {Q}_{t} {P}_{t}^{T} X - {E}_{t} + \frac{{Y}_{1 , t}}{{μ}_{t}} ‖}_{F}^{2} )$$

$$= {( ( β + {μ}_{t} ) I + {μ}_{t} {XX}^{T} )}^{- 1} ( {μ}_{t} {XS}_{3}^{T} {Q}_{t} - {μ}_{t} {S}_{4} )$$

$${Q}_{t + 1} = \frac{{μ}_{t}}{2} {‖ X - XZ - {Q}_{t} {P}_{t + 1}^{T} X - {E}_{t} + \frac{{Y}_{1 , t}}{{μ}_{t}} ‖}_{F}^{2} = \frac{{μ}_{t}}{2} {‖ {S}_{3} - {Q}_{t} {P}_{t + 1}^{T} X ‖}_{F}^{2} , \\ s . t . {Q}^{T} Q = I$$

$${E}_{t + 1} = {min}_{E} λ {‖ E ‖}_{1} + \frac{{μ}_{t}}{2} {‖ X - XZ - {Q}_{t + 1} {P}_{t + 1}^{T} X - E + \frac{{Y}_{1 , t}}{{μ}_{t}} ‖}_{F}^{2}$$

$$= {Ψ}_{\frac{λ}{{μ}_{t}}} ( X - XZ - {Q}_{t + 1} {P}_{t + 1}^{T} X + \frac{{Y}_{1 , t}}{{μ}_{t}} )$$

whereint represents a t-th iteration, 1 represents a full-1 matrix,

$${S}_{1} = X - {Q}_{t} {P}_{t}^{T} X - {E}_{t} + \frac{{Y}_{1 , t}}{{μ}_{t}} , {S}_{2} = {XLX}^{T} , \\ {S}_{3} = X - XZ - E + \frac{{Y}_{1 , t}}{{μ}_{t}} , {S}_{4} = \frac{{Y}_{3 , t}}{{μ}_{t}} - {B}_{t + 1} , and {Ψ}_{\frac{λ}{{μ}_{t}}} ( . )$$

represents soft threshold operation with a threshold being

$$\frac{λ}{{μ}_{t}} .$$

The optimal solution of Qₜ₊₁ can be obtained by means of the following equation:

UΣV^{T}= [symbol] (S₃X^{T}Pₜ₊₁),

[symbol] (⋅) represents a matrix singular value decomposition, Qₜ₊₁=UV^{T}.

An alternating direction method of multipliers is used to optimize and solve the latent low-rank projection learning model, and whether to reach a convergence condition is determined: in response to not, the alternating direction method of multipliers continues being executed for optimization solution and iterative operation; and in response to yes, the projection matrix P of the last iteration is obtained as an optimal low-dimensional projection matrix in response to that a maximum number of iterations or an error of results of two sequential iteration results of a variable is less than a certain set threshold, and iteration is terminated.

At step 5, compute low-dimensional features of the training set and the test set. The step includes: utilize the projection matrix P obtained in step 4 to execute feature extraction operations on the training set X and the test set Y: the low-dimensional features \hat{X}=P^{T}X of the training set X and the low-dimensional features Ŷ=P^{T}Y of the test set Y.

At step 6, use a support vector machine classifier to output classes of all the samples in the test set. The step includes: take the low-dimensional features \hat{X} of the training set X as the training samples of a support vector machine, to classify the low-dimensional features Ŷ of the test set Y, and evaluate performance of a feature extraction method according to final accuracy of classification of the samples in the test set.

The objective, the technical solution and the beneficial effects of the present disclosure are further described in detail by means of the above particular embodiment, and it should be understood that what is mentioned above is only the particular embodiment of the present disclosure and is not intended to limit the present disclosure. Any modifications, equivalent substitutions, improvements, etc. made within the spirit and principles of the present disclosure are intended to fall within the scope of protection of the present disclosure.

What is claimed is:

1. A method for feature extraction of a hyperspectral images based on unsupervised latent low-rank projection learning, comprising:
dividing hyperspectral images data without sample label information into a training set and a test set in proportion;
configuring a robust weight function, to compute a spectral similarity between every two samples in the training set, constructing a spectral constraint matrix according to the training set, and constructing a graph regularization constraint according to a locality preserving projection rule;
approximately decompose row representation coefficients of a latent low-rank representation model into a product of two matrices of the same scale, and constructing a latent low-rank projection learning model with one of the matrices as a projection matrix in combination with the spectral constraint matrix and the graph regularization constraint;
optimizing and solving the latent low-rank projection learning model by means of an alternating direction method of multipliers, to obtain a low-dimensional projection matrix and extract low-dimensional representation features of the test set; and
outputting classes of all samples in the test set through a classifier of a support vector machine, and taking low-dimensional features of the training set as training samples of the support vector machine, to classify the low-dimensional features of the test set, to obtain a classification result, wherein the quality of the classification results is used for evaluating performance of feature extraction.

2. The method for feature extraction of the hyperspectral images based on the unsupervised latent low-rank projection learning as claimed in claim 1, wherein dividing the hyperspectral images data without the sample label information into the training set and the test set in proportion comprises:
dividing the hyperspectral images data with (N+M) samples into the training set comprising N samples, a test set X=[x₁,x₂, . . . ,x_{N}]∈R^{d×N} comprising M samples, and a test set Y=[y₁,y₂, . . . ,y_{M}]∈R^{d×M} comprising M samples in a set proportion, wherein R represents a real number space, and d represents a spectral dimension of each sample.

3. The method for feature extraction of the hyperspectral images based on the unsupervised latent low-rank projection learning as claimed in claim 1, wherein constructing the spectral constraint matrix according to the training set comprises:
constructing the spectral constraint matrix C according to the training set; and
configuring the robust weight function comprises:
configuring the robust weight function of an ij-th element Cᵢⱼ in the spectral constraint matrix C:
$${C}_{ij} = 1 - {( 1 - {( \frac{dist ( {x}_{i} , {x}_{j} )}{{max}_{∀ i} ( dist ( {x}_{i} , {x}_{j} ) )} )}^{2} )}^{2}$$
wherein xᵢ represents an i-th training sample, xⱼ represents a j-th training sample, dist(xᵢ,xⱼ) represents a Euclidean distance between the training sample xᵢ and the training sample xⱼ, ∀ represents any element, and max_{∀i}(dist(xᵢ,xⱼ)) represents a maximum value of a distance between any sample xᵢ with a mark number i and the sample xⱼ.

4. The method for feature extraction of the hyperspectral images based on the unsupervised latent low-rank projection learning as claimed in claim 1, wherein constructing the graph regularization constraint according to the locality preserving projection rule comprises:
an expression for constructing, according to the locality preserving projection rule, the graph regularization constraint is as follows:
$${min}_{{P}^{T} {XDX}^{T} P} {\sum }_{i , j = 1}^{N} {‖ {P}^{T} {x}_{i} - {P}^{T} {x}_{j} ‖}_{2}^{2} {W}_{ij} = {min}_{Tr ( {P}^{T} {XDX}^{T} P = 1 )} Tr ( {P}^{T} {XLX}^{T} P )$$
wherein min represents a minimum value of the function, P represents a projection matrix, i and j represents element mark numbers, Σ represents the sum of elements, ∥⋅∥₂² represents a square of a 2-norm, xᵢ represents an i-th training sample, xⱼ represents a j-th training sample, T represents a transpose of a matrix, Wᵢⱼ represents an ij-th element of the graph weight matrix W, D is a diagonal matrix, a diagonal element of the diagonal matrix is the sum of each row or each column of the graph weight matrix, Tr(⋅) represents a trace of the matrix, and L represents a Laplacian matrix.

5. The method for feature extraction of the hyperspectral images based on the unsupervised latent low-rank projection learning as claimed in claim 1, wherein the latent low-rank representation model is represented as:
$${min}_{Z , L , E} {‖ Z ‖}_{*} + {‖ L ‖}_{*} + λ {‖ E ‖}_{2 , 1} , s . t . X = XZ + LX + E ,$$
wherein min represents a minimum value of a function, Z represents a column space representation coefficient, L represents a row space representation coefficient, E represents noise, λ represents a regularization parameter, s.t. represents a constraint, X represents a training sample set, ∥⋅∥_{*} represents a nuclear norm of a matrix, and ∥⋅∥_{2,1} represents a 21-norm of the matrix.

6. The method for feature extraction of the hyperspectral images based on the unsupervised latent low-rank projection learning as claimed in claim 1, wherein the row space representation coefficients are decomposed to represent by the product of the two matrices with the same dimension, and the representation of the row space representation coefficients is further transformed to obtain
$${min}_{Z , P , Q , E} {‖ Z ‖}_{*} + \frac{β}{2} {‖ P ‖}_{F}^{2} + λ {‖ E ‖}_{1} , s . t . X = XZ + {QP}^{T} X + E , {Q}^{T} Q = I ,$$
wherein P and Q represent decomposition matrices, β represents a regularization parameter, F is a flag of an F-norm, ∥⋅∥_{F}² represents a square of the F-norm of the matrix, ∥⋅∥₁ represents a 1-norm of the matrix, T represents a transpose of the matrix, and I represents a unit matrix.

7. The method for feature extraction of the hyperspectral images based on the unsupervised latent low-rank projection learning as claimed in claim 6, wherein optimizing and solving the latent low-rank projection learning model by means of the alternating direction method of multipliers, to obtain the low-dimensional projection matrix comprises:
solving the latent low-rank projection learning model and introducing an auxiliary variable A and a variable B by means of an alternating direction method of multipliers, to obtain an optimization
$${min}_{Z , P , Q , A , B , E} {‖ C ⊙ A ‖}_{*} + \frac{β}{2} {‖ P ‖}_{F}^{2} + λ {‖ E ‖}_{1} + γ Tr ( {B}^{T} {XLX}^{T} B ) ,$$
model as follows: s.t. X=XZ+QP^{T}X+E,Z=A,P=B,Q^{T}Q=I, and
a Lagrangian function of the optimization model as follows:
$$ℓ ( Z , A , P , B , Q , E )$$
$$= {‖ C ⊙ A ‖}_{*} + \frac{β}{2} {‖ P ‖}_{F}^{2} + λ {‖ E ‖}_{1} + γ Tr ( {B}^{T} {XLX}^{T} B )$$
$$+ 〈 {Y}_{1} , X - XZ - {QP}^{T} X - E 〉 + 〈 {Y}_{2} , Z - A 〉 + 〈 {Y}_{3} , P - B 〉$$
$$+ \frac{μ}{2} ( {‖ X - XZ - {QP}^{T} X - E ‖}_{F}^{2} + {‖ Z - A ‖}_{F}^{2} + {‖ P - B ‖}_{F}^{2} )$$
wherein [symbol] (⋅) represents the Lagrangian function, [symbol] ⋅ [symbol] represents a matrix inner product, Y₁, Y₂ and Y₃ represent Lagrangian multipliers, and μ represents a penalty factor.

8. The method for feature extraction of the hyperspectral images based on the unsupervised latent low-rank projection learning as claimed in claim 7, wherein matrices in the Lagrangian function are initialized: Z=A=0, P=B=0, E=0, Y₁=0, Y₂=0 and Y₃=0, and variable values of a (t+1)-th iteration are as follows:
$${A}_{t + 1} = {min}_{A} {‖ C ⊙ A ‖}_{*} + \frac{{μ}_{t}}{2} {‖ {Z}_{t} - A + \frac{{Y}_{2 , t}}{{μ}_{t}} ‖}_{F}^{2} = ( {μ}_{t} {Z}_{t} + {Y}_{2 , t} ) / ( 2 ( C ⊙ C ) + {μ}_{t} 1 ) ,$$
$${Z}_{t + 1} = \frac{{μ}_{t}}{2} ( {‖ X - XZ - {Q}_{t} {P}_{t}^{T} X - {E}_{t} + \frac{{Y}_{1 , t}}{{μ}_{t}} ‖}_{F}^{2} + {‖ Z - {A}_{t + 1} + \frac{{Y}_{2 , t}}{{μ}_{t}} ‖}_{F}^{2} )$$
$$= {( {X}^{T} X + I )}^{- 1} ( {X}^{T} {S}_{1} + {A}_{t + 1} - \frac{{Y}_{2 , t}}{{μ}_{t}} )$$
$${B}_{t + 1} = γ Tr ( {B}^{T} {XLX}^{T} B ) + \frac{{μ}_{t}}{2} ( {‖ P - {B}_{t + 1} + \frac{{Y}_{3 , t}}{{μ}_{t}} ‖}_{F}^{2} + {‖ X - XZ - {Q}_{t} {P}_{t}^{T} X - {E}_{t} + \frac{{Y}_{1 , t}}{{μ}_{t}} ‖}_{F}^{2} )$$
$$= {( ( β + {μ}_{t} ) I + {μ}_{t} {XX}^{T} )}^{- 1} ( {μ}_{t} {XS}_{3}^{T} {Q}_{t} - {μ}_{t} {S}_{4} )$$
$${Q}_{t + 1} = \frac{{μ}_{t}}{2} {‖ X - XZ - {Q}_{t} {P}_{t + 1}^{T} X - {E}_{t} + \frac{{Y}_{1 , t}}{{μ}_{t}} ‖}_{F}^{2} = \frac{{μ}_{t}}{2} {‖ {S}_{3} - {Q}_{t} {P}_{t + 1}^{T} X ‖}_{F}^{2} , \\ s . t . {Q}^{T} Q = I$$
$${E}_{t + 1} = {min}_{E} λ {‖ E ‖}_{1} + \frac{{μ}_{t}}{2} {‖ X - XZ - {Q}_{t + 1} {P}_{t + 1}^{T} X - E + \frac{{Y}_{1 , t}}{{μ}_{t}} ‖}_{F}^{2}$$
$$= {Ψ}_{\frac{λ}{{μ}_{t}}} ( X - XZ - {Q}_{t + 1} {P}_{t + 1}^{T} X + \frac{{Y}_{1 , t}}{{μ}_{t}} )$$
$${S}_{1} = X - {Q}_{t} {P}_{t}^{T} X - {E}_{t} + \frac{{Y}_{1 , t}}{{μ}_{t}} , {S}_{2} = {XLX}^{T} , \\ {S}_{3} = X - XZ - E + \frac{{Y}_{1 , t}}{{μ}_{t}} , and {S}_{4} = \frac{{Y}_{3 , t}}{{μ}_{t}} - {B}_{t + 1} ,$$
wherein t represents a t-th iteration, 1 represents a full-1 matrix, λ represents a regularization parameter, and
$${Ψ}_{\frac{λ}{{μ}_{t}}} ( . )$$
represents soft threshold operation with a threshold being
$$\frac{λ}{{μ}_{t}} .$$

9. The method for feature extraction of the hyperspectral images based on the unsupervised latent low-rank projection learning as claimed in claim 1, wherein optimizing and solving the latent low-rank projection learning model by means of the alternating direction method of multipliers, to obtain the low-dimensional projection matrix comprises:
optimizing and solving the latent low-rank projection learning model by means of an alternating direction method of multipliers, to obtain a solution result;
determining whether the solution result reaches a convergence condition, the convergence condition comprising: the solution result reaching a maximum number of iterations or an error between results of two sequential iteration results of a variable being less than a preset threshold;
in response to the solution result not reaching the convergence condition, continuing executing the alternating direction method of multipliers for optimization solution and iterative operation; and in response to the solution result reaching the convergence condition, obtaining the projection matrix P of the last iteration as an optimal low-dimensional projection matrix, and terminating iteration.

10. The method for feature extraction of the hyperspectral images based on the unsupervised latent low-rank projection learning as claimed in claim 1, wherein taking the low-dimensional features of the training set as the training samples of the support vector machine, to classify the low-dimensional features of the test set, to obtain the classification results comprises:
taking the low-dimensional features \hat{X} of the training set X as the training samples of the support vector machine, to classify the low-dimensional features Ŷ of the test set Y, to obtain the classification results, and evaluating performance of a feature extraction algorithm according to final accuracy of classification of the samples in the test set.
